(19) United States
(12) Patent Application Publication
(10) Pub. No.: US 2019/0047804 A1
(43) Pub. Date: Feb. 14, 2019

(54) TRUCK WELL BARRIER SYSTEM

(71) Applicant: Marmon/Keystone LLC, Bolingbrook, IL (US)

(72) Inventor: Daniel W. Ellis, Buford, GA (US)

(21) Appl. No.: 16/059,440

(22) Filed: Aug. 9, 2018

Related U.S. Application Data
(60) Provisional application No. 62/543,055, filed on Aug. 9, 2017.

(51) Int. Cl. B65G 69/28; E01F 13/02

(52) U.S. Cl. CPC B65G 69/2888; B62D 53/062; E01F 13/024

(57) ABSTRACT

A barrier rail system is used with a truck well or drive-through truck bay, in which a truck, such as a flatbed trailer is positioned. The truck well has a floor and opposing upstanding side walls and at least one stanchion positioned on a surface adjacent to and outboard of one of the upstanding side walls. The barrier rail system includes a barrier rail having at least one upright post and at least one post mounted transverse to the upright post. A movable link is mounted to the upright post and mountable to the stanchion. The barrier rail is movable from a stowed position in which the barrier rail is adjacent the upstanding sidewall to a deployed position in which the barrier rail is moved away from the upstanding sidewall and the stanchion and over the well. The system can also be used on drive-through truck bays.

### CROSS-REFERENCE TO RELATED APPLICATION DATA

This application claims the benefit of and priority to Provisional U.S. Patent Application Ser. No. 62/543,055, filed Aug. 9, 2017, titled, Truck Well Barrier System, the disclosure of which is incorporated herein in its entirety.

### BACKGROUND

The present disclosure relates generally to a truck wells and in particular, to barrier systems for truck wells. Truck trailers are often parked in truck wells to facilitate loading and unloading the truck with the loading surface or truck bed at about the same elevation as the surrounding floor, so that loads can be readily loaded onto and off of the bed.

A conventional truck well is defined by a well floor on which the trailer is parked and upstanding side walls. The walls extend upwardly to about the height of the trailer bed. Typically, the well walls are contiguous with the surrounding floor of the facility.

The walls are spaced from one another to accommodate the width of a standard flatbed trailer and additional space for moving the trailer into and out of the well. As such, gaps are defined between the edges or sides of the bed and the well walls. Although the widths of flatbeds are fairly standardized, bed widths do vary to some extent. As such, the size of the gap between the bed and the well walls will also vary.

Depending upon on the width of the bed, the width of the gaps can be small or they can be large.

Accordingly, there is a need for a truck well barrier system that provides a barrier for personnel on a truck bed. Desirably, such a system is readily moved between a stored state and a deployed state and extends from the floor surrounding the well to the sides of the truck bed. More desirably still, such a barrier system can accommodate trucks or truck beds of varying widths. Still more desirably, such a system can be deployed in sections to accommodate various length trucks.

### SUMMARY

A barrier rail system is used in connection with a truck well in which a truck, such as a flatbed trailer is positioned. The truck well has a floor and opposing upstanding side walls, and at least one stanchion positioned on a surface adjacent to and outboard of one of the side walls.

According to one aspect, the barrier rail system includes a barrier rail having at least one upright post and at least one post mounted to the upright post transverse thereto. A movable link is mounted to the upright post and is mountable to the stanchion. The barrier rail is movable from a stowed position in which the barrier rail is adjacent the upstanding sidewall to a deployed position in which the barrier rail is moved to away from the upstanding sidewall and the stanchion, and over the well.

In an embodiment, the barrier rail includes a plurality of upright posts spaced from one another and two or more movable links. The movable links are mounted to different ones of the upright posts. The movable link member can be a rigid link member that is pivotally mounted to the upright post. The system can include two movable links, the two movable links mounted to the same upright post.

In an embodiment, the barrier rail includes at least two upright posts and two links extending between stanchions and the upright posts. The links can be pivotally mounted to the upright post and to the stanchion, the links can be telescopically mounted between the upright post and the stanchion and the links can be both telescopically and pivotally mounted between the upright post and the stanchion. In an embodiment, the link is an accordion or a scissor-type link.

The system can used a manually positioned rod to secure the barrier rail. In an embodiment, the system can use an actuator to move the barrier rail between the stowed position and the deployed position. Such an actuated system can be used with either the telescopic or the pivotal mounting as well as the telescopic and pivotal mounting.

In an embodiment, the barrier rail is formed from a plurality of rail sections, each rail section being mounted to adjacent rail sections. The adjacent rail sections are mounted to one another by a flange plate. In such an embodiment, the link or links can be mounted to one or more flange plates.

In an embodiment, each rail section has a pair of upright posts and is formed as an elongated A-shaped section having a flat top and an intermediate rail extending between legs of the A-shaped section.

In another aspect, a barrier rail system is configured for use in a drive-through truck bay (a truck bay without side walls). In such an arrangement, the system is used with a truck having a bed at a height and a stanchion adjacent the truck bed and defining a gap between the stanchion and the truck bed. Such a drive-through tuck bay barrier rail system includes a barrier rail having at least one upright post and at least one post mounted to the upright post transverse thereto and a movable link mounted to the upright post and mountable to the stanchion. The barrier rail is mountable to the stanchion and is movable from a stowed position in which the barrier rail is adjacent the stanchion to a deployed position in which the barrier rail is moved away from the stanchion toward the truck bed to reduce a gap between the truck bed and the barrier rail.

In an embodiment, a plurality of upright posts are spaced from one another and include two movable links, the movable links mounted to different ones of the upright posts. The movable link member can be a rigid link member that is pivotally mounted to the upright post. The system can include two movable links, each movable link mounted to the same upright post. In an embodiment, the barrier rail includes at least two upright posts and includes two links extending between stanchions and at least two of the at least two upright posts.

In an embodiment, the link or links are pivotally mounted to the upright post and to the stanchion. The link or links can be is telescopically mounted between the upright post and the stanchion. And, the links can be telescopically and pivotally mounted between the upright post and the stanchion. In an embodiment, the link or links are accordion or a scissor-type links.

In an embodiment, the system includes one or more actuators to move the barrier rail between the stowed position and the deployed position. The actuators can be configured to telescopically and/or pivotally move the barrier rail.

In an embodiment, the barrier rail is formed from a plurality of rail sections, each rail section being mounted to adjacent rail sections. Adjacent rail sections can be mounted to one another by one or more flange plates such that the links are mounted to the flange plates.

In an embodiment, each rail section has a pair of upright posts and is formed as an elongated A-shaped section having a flat top and including an intermediate rail extending between legs of the A-shaped section.

These and other features and advantages of the present invention will be apparent from the following detailed description, in conjunction with the appended claims.

### BRIEF DESCRIPTION OF THE DRAWINGS

FIG. 1 is a perspective illustration of an embodiment of a truck well barrier system in a stowed state;

FIG. 2 is a perspective illustration of the system of FIG. 1 in a deployed state;

FIGS. 3A-3C are rear view illustrations of a flatbed truck in a various parking/loading scenarios in which in FIG. 3A the flatbed truck is positioned in a conventional truck well with the barrier system deployed, in FIG. 3B the flatbed truck is positioned outside of a truck well (in a drive-through truck bay) and the barrier system deployed, and in FIG. 3C two flatbed trucks are positioned in side-by-side conventional trucks well with the barrier system deployed;

FIGS. 4A and 4B illustrate an embodiment of the link member extending between the dock stanchion and the barrier rail, in which FIG. 4A shows a telescopic link member when the barrier rail is in a deployed state and FIG. 4B shows the telescopic link member when the barrier rail is in a stowed state;

FIGS. 5A and 5B illustrate another embodiment of the link member that extends between the dock stanchion and barrier rail, in which FIG. 5A shows the accordion or scissor link member when the barrier rail is in the deployed state and FIG. 5B shows the accordion or scissor link member when the barrier rail is in the stowed state;

FIG. 6 illustrates an embodiment of an actuated link member; and

FIGS. 7A-7C illustrate one embodiment of the truck well barrier system as it is moved from the stowed state (FIG. 7A) through an intermediate state (FIG. 6B) to the deployed state (FIG. 7C).

### DETAILED DESCRIPTION

While the present device is susceptible of embodiment in various forms, there is shown in the figures and will hereinafter be described a presently preferred embodiment with the understanding that the present disclosure is to be considered an exemplification of the device and is not intended to be limited to the specific embodiment illustrated.

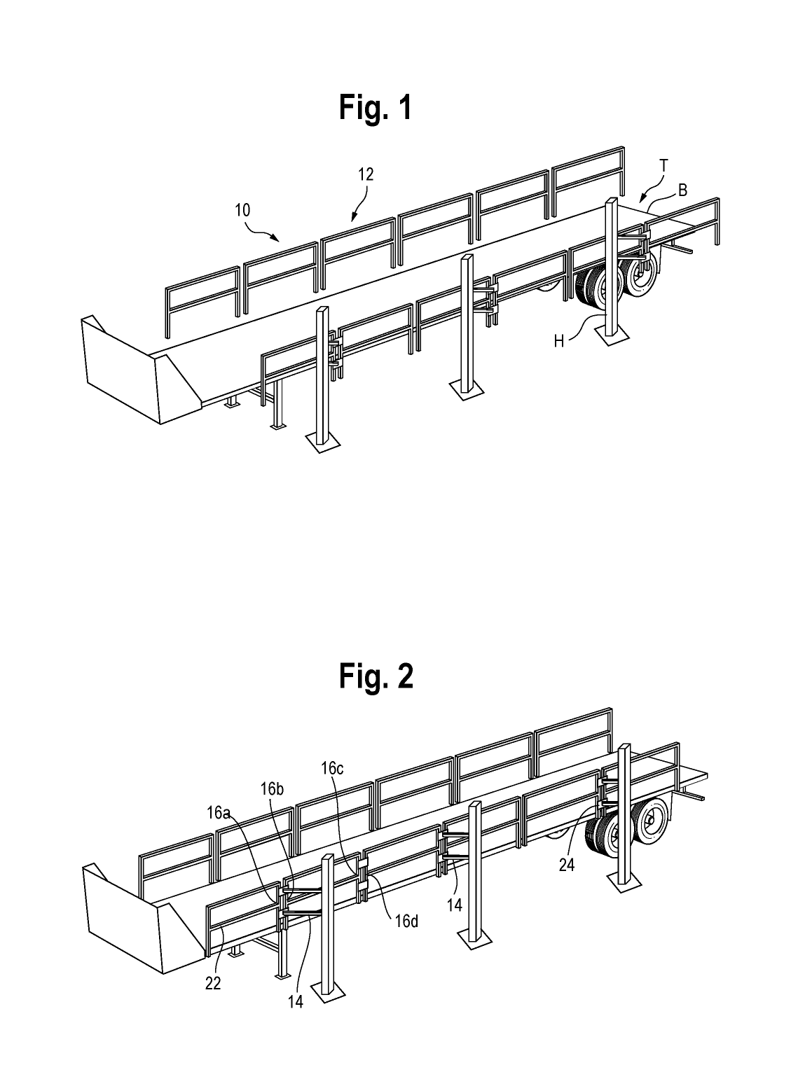

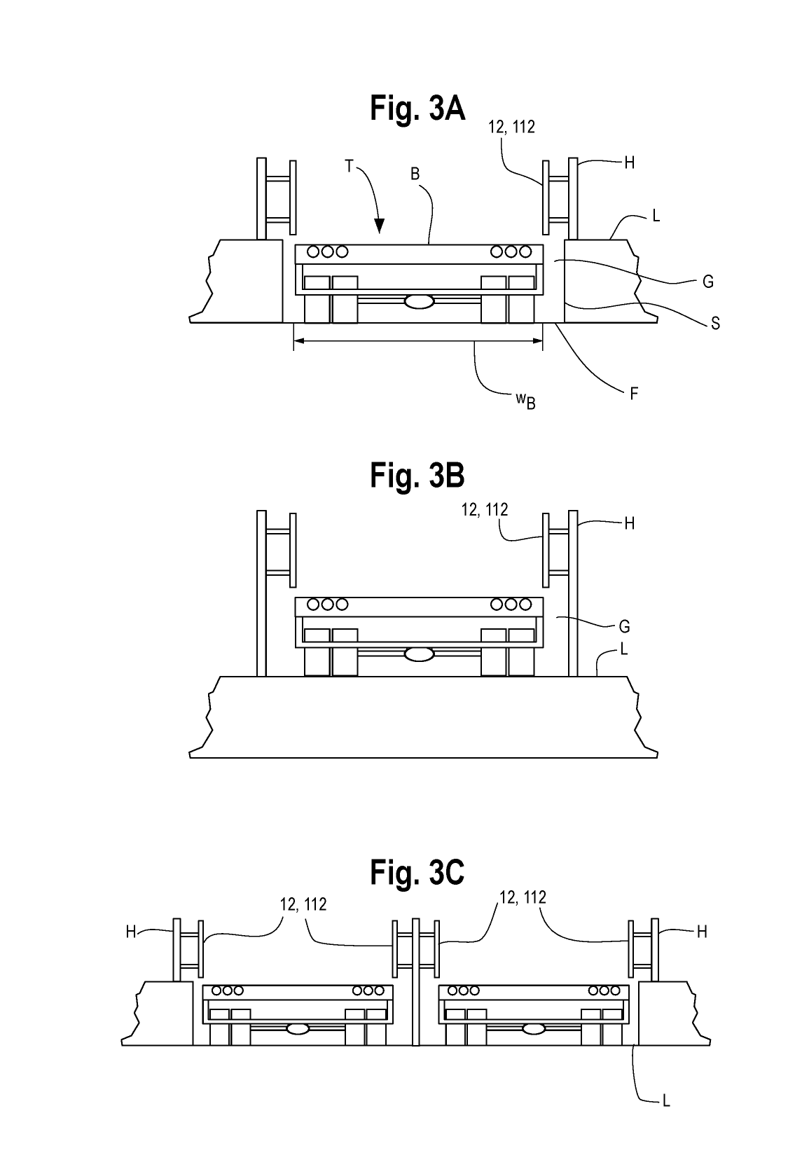

Referring now to the figures and in particular to FIG. 1 there is shown an embodiment of a truck well barrier system 10. Referring briefly to FIG. 3A, the system 10 is for use in connection with a truck well W and a truck T, for example a flatbed truck or trailer parked within the well W. As noted above, a conventional truck well W is defined by the well floor F on which the trailer is parked and upstanding side walls S. The walls S extend upwardly to about the height of the trailer bed B. Typically, the well walls S are contiguous with the surrounding floor L of the facility.

The walls S are spaced from one another to accommodate the width of a standard flatbed trailer T and additional space for moving the trailer T into and out of the well W. Gaps G are defined between the sides of the bed B and the well walls S. Although the widths of flatbeds B are fairly standardized, bed widths w_{B} do vary, and as such, the size of the gap G between the bed D and the well walls S will vary.

In some scenarios, the truck may not be positioned in a truck well (see, e.g., FIGS. 3B and 3C). For example, as seen in FIG. 3B, the truck may be parked in an area where loading and unloading occurs outside of a well, for example in a dock without elevated walls on either side or in a drive-through truck bay. Or, as seen in FIG. 3C, truck wells may be arranged in a side-by-side configuration with well walls on one side of each of the trucks without an elevated wall between the trucks/separate wells. It will be appreciated that the present barrier system can be used in such scenarios in which the stanchions to which the barrier system 10 is installed are not located on an elevated wall, but are located on a facility floor or somewhere between a floor and truck well wall.

Referring back to FIG. 1, the barrier system 10 includes a barrier rail 12 and link members 14 that extend between and mount the barrier rail 12 to stanchions H. The stanchions H are typically mounted to the surrounding facility floor L at about the edge of the well W. The barrier rail 12 can take many forms. For example, as shown, the barrier rail 12 can be formed from metal posts, and can include upright (vertical) posts 16 with horizontal members 18 between the upright posts 16. In one embodiment the rail 12 is formed from a pair of upright posts 16 with an upper horizontal member 18 and an intermediate or lower horizontal member 20 between the upper member 18 and the bottom of the vertical posts 16. Such a configuration can take the shape of an elongated “A” with a flat top in place of the peak of the “A”. In an embodiment, the barrier rail 12 is formed from a plurality of flat-top “A” shaped rail sections 22 joined to one another. In an embodiment, the upper member 18 is at a height of about 36 inches; it will however be appreciated by those skilled in the art that the height of the upper member 18 can vary, as can the height of the intermediate or lower member 20.

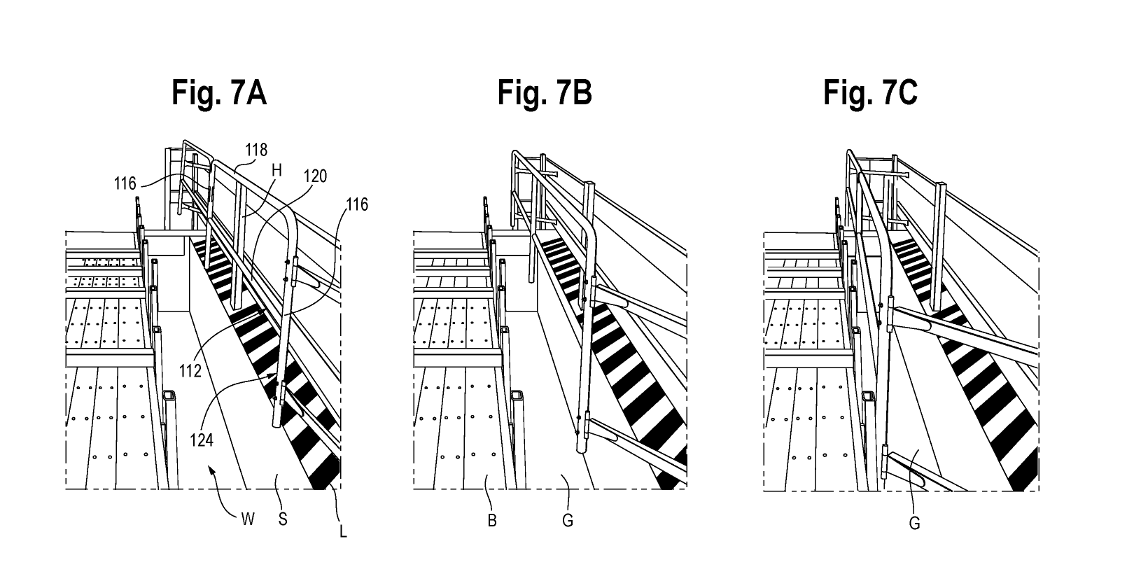

Referring briefly to FIGS. 7A-7C, in another embodiment, the barrier rail 112 can be formed as a single elongated member in which the outer upright, vertical posts 116 and the top rail 118 are formed from a single shaped (bent) member having in inverted U-shape that form a frame 124. One or more vertical members 116 and horizontal members 120 can be affixed to the frame 124 to provide additional support and rigidity to the barrier rail 112. Various other configurations of the barrier rail will be appreciated by those skilled in the art, which other configurations are within the scope and spirit of the present disclosure.

The barrier rail 12, 112 can extend about the length of a truck bed B or it may extend for a length shorter or longer than the bed B. In the embodiment of FIGS. 1-2, 5 and 6, the barrier rail 12 is formed from a plurality of rail sections 22 secured to one another to define a substantially linear barrier. In an embodiment the rail sections 22 are fixedly joined to one another, such as by a flange plate 24 that is fastened to the vertical posts 16 of adjacent rail sections 22. Alternately, the rail sections 22 can be hingedly mounted to one another.

The link members 14 (referred to herein as links) extend between the stanchions H and the barrier rail 12, 112. In an embodiment, the links 14 are affixed to the flange plates 24 connecting rail sections 22 and are affixed to the stanchions H. The links 14 may be rigid members. In the embodiment shown in FIGS. 1-2, the links 14 are hingedly mounted to the barrier rail 12 (at the flange plates 24) and hingedly mounted to the stanchions H. In this manner, the barrier rail 12 pivots about 90 degrees between the stowed position (FIG. 1) and the deployed position (FIG. 2). It will be understood that in the stowed position, the barrier rail 12 is abutting or adjacent the stanchions H, out of the path of, for example, a trailer T backing in to the well W, and in the deployed position, the barrier rails 12 are extended toward and in some cases, onto the trailer bed B.

In an embodiment, two links 14 are mounted to each pair of adjacent uprights 16a,b to which the links 14 are mounted. That is, links 14 are not mounted to each pair of adjacent uprights (see, 16c,d), but each pair of adjacent uprights 16a,b that include links 14, includes at least a pair of links 14. This configuration increases the overall stability of the barrier rail system 10. The barrier rail 12 can be secured in position by a hinged rod (not shown) that pivots and extends from the stanchion H to the rail 12 or from the rail 12 to the stanchion H in a manual locking system.

Although not shown, a stop can be configured on the system to stop rotation of the barrier rail 12, 112 at about the 90 degree, fully deployed position. Alternately, the rail 12, 112 can be configured to freely rotate about 180 degrees from the stowed position, through the deployed position and back to the opposite stowed position.

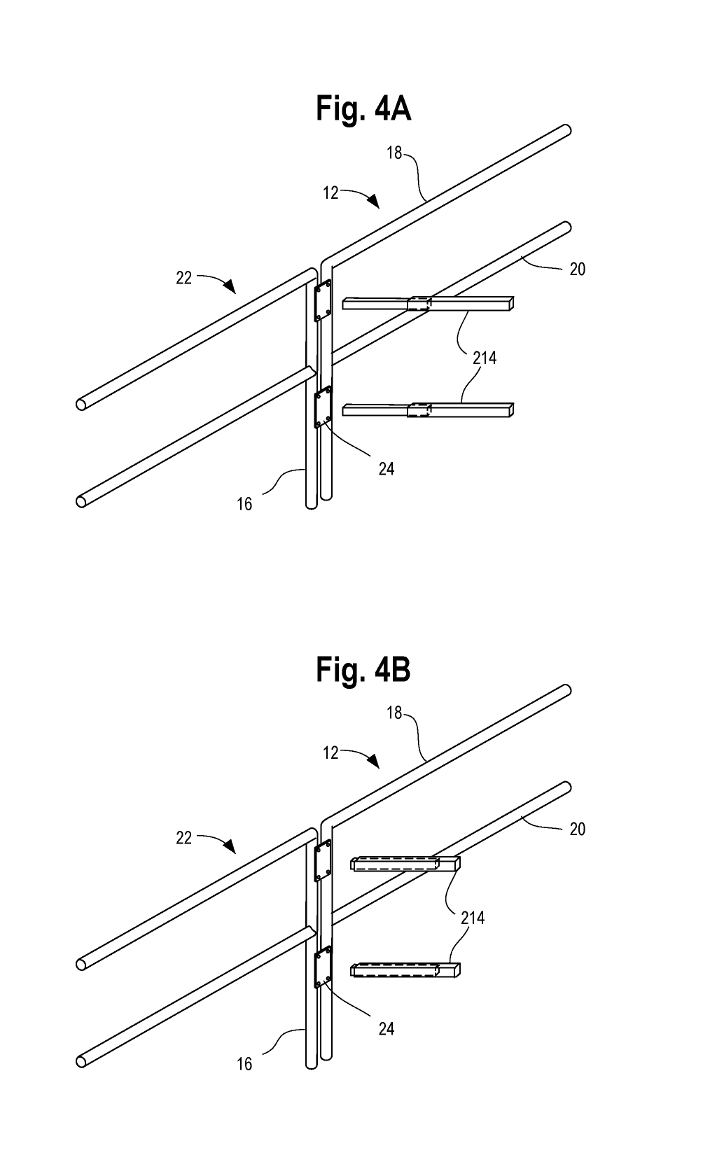

In another embodiment, illustrated in FIGS. 4A and 4B, the links 214 are telescopic members that telescope from the deployed position to the stowed position (the link 214 alone being shown in FIG. 3B). The link 214 can be fixedly mounted to the stanchion H and the barrier rail 12, 112 such that the only movement of the barrier rail 12, 112 is toward and away from the bed H and stanchion H, or the telescopic links 214 can be hingedly mounted to the stanchion H and to the barrier rail 12, 112 such that movement of the barrier rail 12, 112 relative to the stanchion H can be independently both pivotal and telescopic (reciprocating). In addition to other benefits, such an arrangement can facilitate the accommodation of trailer beds B of different widths.

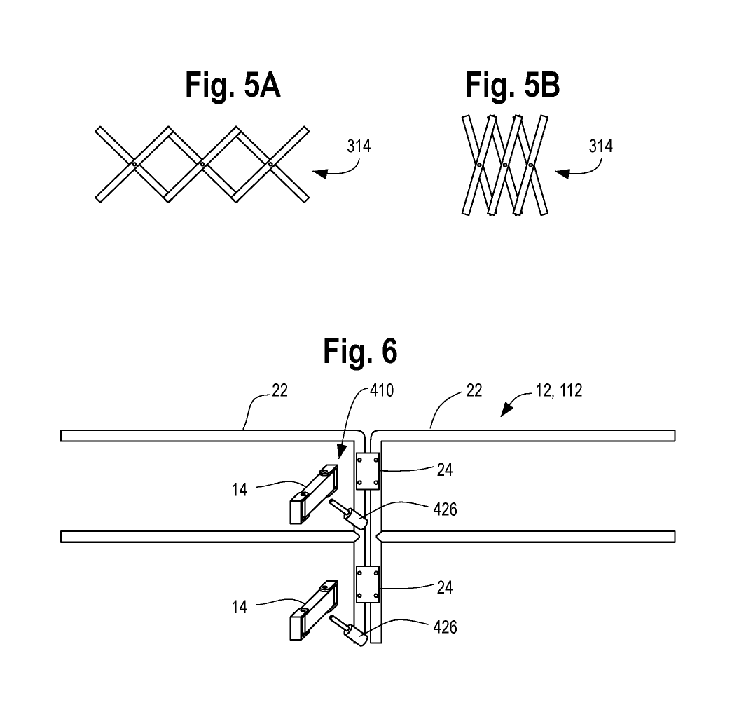

In still another embodiment shown in FIGS. 5A and 5B, the link 314 can be in the form of an accordion of scissor-type link mounted to the stanchion H and to the barrier rail 12, 112. As in the earlier embodiments, the accordion or scissor-type link 314 can be mounted to the stanchion H and the barrier rail 12, 112 so as to pivot (e.g., mounted by hinges) in addition to the extension and retraction of such a link 314 configuration., so that the rail 12, 112, is independently both pivotal and telescopic (scissoring).

FIG. 6 illustrates, schematically, a truck well barrier system 410 that includes an actuator 426. The actuator 426 can be, for example, a pneumatic actuator, an electric actuator, an electro-mechanical actuator, or any type of actuator that is powered so as to move the barrier rail 12, 112 between the stowed and deployed positions. It will be appreciated that such an actuated system 410 can be operated by an operator by, for example, a switch or button (not shown) located on or remotely from the barrier rail system 410. Such an actuated system 410 can be configured to power either or both of a pivotal and a telescopic (and scissoring) movement.

By way of example, FIGS. 7A-7C illustrate the manual actuation of the barrier rail system 110 from the stowed position (FIG. 7A) through an intermediate position (FIG. 7B) to the fully deployed position (FIG. 7C). In this example, the barrier rail 112 is manually actuated (manually moved) from the stowed position to the deployed position by the operator grasping the barrier rail 112 and rotating it outwardly toward and up to the edge of the trailer bed B.

It is understood the various features from any of the embodiments above are usable together with the other embodiments described herein. Further, it is understood that same or similar terminology used across the different embodiments above refers to the same or similar component, with the exception of any differences described or shown in the figures. It will also be appreciated by those skilled in the art that the relative directional terms such as sides, upper, lower, rearward, forward and the like are for explanatory purposes only and are not intended to limit the scope of the disclosure.

All patents referred to herein, are hereby incorporated herein by reference, whether or not specifically done so within the text of this disclosure.

In the present disclosure, the words “a” or “an” are to be taken to include both the singular and the plural. Conversely, any reference to plural items shall, where appropriate, include the singular.

From the foregoing it will be observed that numerous modifications and variations can be effectuated without departing from the true spirit and scope of the novel concepts of the present disclosure. It is to be understood that no limitation with respect to the specific embodiments illustrated is intended or should be inferred. The disclosure is intended to cover all such modifications as fall within the scope of the claims.

What is claimed is:

1. A barrier rail system for use with a truck well in which a truck, such as a flatbed trailer is positioned, the truck well having a floor and opposing upstanding side walls and having at least one stanchion positioned on a surface adjacent to and outboard of one of the upstanding side walls, the barrier rail system comprising:
a barrier rail having at least one upright post and at least one post mounted to the upright post transverse thereto; and
a movable link mounted to the upright post and mountable to the stanchion,
wherein the barrier rail is movable from a stowed position in which the barrier rail is adjacent the upstanding sidewall to a deployed position in which the barrier rail is moved to away from the upstanding sidewall and the stanchion, and over the well.

2. The system of claim 1, including a plurality of upright posts spaced from one another and including two movable links, the movable links mounted to different ones of the upright posts.

3. The system of claim 1, wherein the movable link member is a rigid link member and is pivotally mounted to the upright post.

4. The system of claim 1, including two movable links, the movable links mounted to a same upright post.

5. The system of claim 1 wherein the barrier rail includes at least two upright posts and including two links extending between stanchions and at least two of the at least two upright posts.

6. The system of claim 1 wherein the link is pivotally mounted to the upright post and to the stanchion.

7. The system of claim 1 wherein the link is telescopically mounted between the upright post and the stanchion.

8. The system of claim 6 wherein the link is telescopically mounted between the upright post and the stanchion.

9. The system of claim 1 wherein the link is an accordion or a scissor-type link.

10. The system of claim 6 wherein the link is an accordion or a scissor-type link.

11. The system of claim 1 including an actuator to move the barrier rail between the stowed position and the deployed position.

12. The system of claim 1 wherein the barrier rail is formed from a plurality of rail sections, each rail section being mounted to adjacent rail sections.

13. The system of claim 12 wherein adjacent rail sections are mounted to one another by a flange plate and wherein the link is mounted to the flange plate.

14. The system of claim 13 wherein adjacent rail sections are mounted to one another by a pair of flange plates and wherein links are mounted to some of the pairs of flange plates.

15. The system of claim 12 wherein each rail section has a pair of upright posts and is formed as an elongated A-shaped section having a flat top and including an intermediate rail extending between legs of the A-shaped section.

16. A barrier rail system for use with a truck having a bed at a height and a stanchion adjacent the truck bed and defining a gap between the stanchion and the truck bed, the barrier rail system comprising:
a barrier rail having at least one upright post and at least one post mounted to the upright post transverse thereto; and
a movable link mounted to the upright post and mountable to the stanchion,
wherein the barrier rail is mountable to the stanchion and is movable from a stowed position in which the barrier rail is adjacent the stanchion to a deployed position in which the barrier rail is moved away from the stanchion toward the truck bed to reduce a gap between the truck bed and the barrier rail.

17. The system of claim 16, including a plurality of upright posts spaced from one another and including two movable links, the movable links mounted to different ones of the upright posts.

18. The system of claim 16, wherein the movable link member is a rigid link member and is pivotally mounted to the upright post.

19. The system of claim 16, including two movable links, the movable links mounted to a same upright post.

20. The system of claim 16 wherein the barrier rail includes at least two upright posts and including two links extending between stanchions and at least two of the at least two upright posts.

21. The system of claim 16 wherein the link is pivotally mounted to the upright post and to the stanchion.

22. The system of claim 16 wherein the link is telescopically mounted between the upright post and the stanchion.

23. The system of claim 21 wherein the link is telescopically mounted between the upright post and the stanchion.

24. The system of claim 16 wherein the link is an accordion or a scissor-type link.

25. The system of claim 21 wherein the link is an accordion or a scissor-type link.

26. The system of claim 16 including an actuator to move the barrier rail between the stowed position and the deployed position.

27. The system of claim 16 wherein the barrier rail is formed from a plurality of rail sections, each rail section being mounted to adjacent rail sections.

28. The system of claim 27 wherein adjacent rail sections are mounted to one another by a flange plate and wherein the link is mounted to the flange plate.

29. The system of claim 28 wherein adjacent rail sections are mounted to one another by a pair of flange plates and wherein links are mounted to some of the pairs of flange plates.

30. The system of claim 27 wherein each rail section has a pair of upright posts and is formed as an elongated A-shaped section having a flat top and including an intermediate rail extending between legs of the A-shaped section.
